(19) United States
(12) Patent Application Publication
(10) Pub. No.: US 2017/0262996 A1
(43) Pub. Date: Sep. 14, 2017

(54) ACTION LOCALIZATION IN SEQUENTIAL DATA WITH ATTENTION PROPOSALS FROM A RECURRENT NETWORK

(71) Applicant: QUALCOMM Incorporated, San Diego, CA (US)

(72) Inventors: Mihir JAIN, Amsterdam (NL); Zhenyang LI, Amsterdam (NL); Efstratios GAVVES, Amsterdam (NL); Cornelis Gerardus Maria SNOEK, Volendam (NL)

(21) Appl. No.: 15/250,755

(22) Filed: Aug. 29, 2016

Related U.S. Application Data
(60) Provisional application No. 62/307,359, filed on Mar. 11, 2016.

(51) Int. Cl. G06T 7/00; G06N 3/04; G06K 9/62; G06K 9/32; G06K 9/40

(52) U.S. Cl. CPC G06T 7/0087; G06K 9/3216; G06K 9/40; G06K 9/3241; G06K 9/628; G06N 3/0445; G06T 2210/12; G06T 2207/10016

(57) ABSTRACT

A method generates bounding-boxes within frames of a sequence of frames. The bounding-boxes may be generated via a recurrent neural network (RNN) such as a long short-term memory (LSTM) network. The method includes receiving the sequence of frames and generating an attention feature map for each frame of the sequence of frames. Each attention feature map indicates at least one potential moving object. The method also includes up-sampling each attention feature map to determine an attention saliency for pixels in each frame of the sequence of frames. The method further includes generating a bounding-box within each frame based on the attention saliency and temporally smoothing multiple bounding-boxes along the sequence of frames to obtain a smooth sequence of bounding-boxes. The method still further includes localizing an action location within each frame based on the smooth sequence of bounding-boxes.

### CROSS-REFERENCE TO RELATED APPLICATION

The present application claims the benefit of U.S. Provisional Patent Application No. 62/307,359, filed on Mar. 11, 2016, and titled “ACTION LOCALIZATION IN SEQUENTIAL DATA WITH ATTENTION PROPOSALS FROM A RECURRENT NETWORK,” the disclosure of which is expressly incorporated by reference herein in its entirety.

### BACKGROUND

Field

Certain aspects of the present disclosure generally relate to machine learning and, more particularly, to improving systems and methods for generating attention to actions in sequential data using a neural network such as an attention recurrent neural network (RNN).

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Recurrent neural networks (RNNs) are a class of neural network, which includes a cyclical connection between nodes or units of the network. The cyclical connection creates an internal state that may serve as a memory that enables recurrent neural networks to model dynamical systems. That is, these cyclical connections offer recurrent neural networks the ability to encode memory and as such, these networks, if successfully trained, are suitable for sequence learning applications.

A recurrent neural network may be used to implement a long short-term memory (LSTM) in a microcircuit composed of multiple units to store values in memory using gating functions and multipliers. LSTMs are able to hold a value in memory for an arbitrary length of time. As such, LSTMs may be useful in learning, classification systems (e.g., handwriting and speech recognition systems), and other applications.

In conventional systems, a recurrent network, such as a recurrent neural network, is used to model sequential data. Recurrent neural networks may handle vanishing gradients. Thus, recurrent neural networks may improve the modeling of data sequences. Consequently, recurrent neural networks may improve the modelling of the temporal structure of sequential data, such as videos.

Still, in conventional recurrent neural networks (e.g., standard recurrent neural networks), input dimensions are treated equally, as all dimensions equally contribute to the internal state of the conventional recurrent neural network unit. For sequential data, such as videos, some dimensions are more important than others. Moreover, at different times, different dimensions may be more important than other dimensions.

For example, in a video with action, the locations with the action should have a greater weight and an increased contribution to the internal state of the recurrent neural network. Therefore, conventional systems have proposed an attention recurrent neural network model that predicts an attention saliency vector for the input that weighs different dimensions according to their importance. That is, the attention recurrent neural network model predicts regions in the frame that are more relevant to the actions of interest. More specifically, the attention recurrent neural network may treat the spatial dimensions of its input differently by varying the weights corresponding to different spatial dimensions.

### SUMMARY

In one aspect of the present disclosure, a method generates bounding-boxes within frames of a sequence of frames. The bounding-boxes may be generated via a recurrent neural network (RNN) such as a long short-term memory (LSTM) network. Additionally, the bounding-boxes may be generated as the frames are received.

The method includes receiving the sequence of frames. The method also includes generating an attention feature map for each frame of the sequence of frames. Each attention feature map indicates at least one potential moving object. The method further includes up-sampling each attention feature map to determine an attention saliency for pixels in each frame of the sequence of frames. The method still further includes generating a bounding-box within each frame based on the attention saliency. The method also further includes temporally smoothing multiple bounding-boxes along the sequence of frames to obtain a smooth sequence of bounding-boxes. The method still further includes localizing an action location within each frame based on the smooth sequence of bounding-boxes.

Another aspect of the present disclosure is directed to an apparatus that generates bounding-boxes within frames of a sequence of frames. The bounding-boxes may be generated via a recurrent neural network (RNN) such as a long short-term memory (LSTM) network. The apparatus includes means for receiving the sequence of frames. The apparatus also includes means for generating an attention feature map for each frame of the sequence of frames. Each attention feature map indicates at least one potential moving object. The apparatus further includes means for up-sampling each attention feature map to determine an attention saliency for pixels in each frame. The apparatus still further includes means for generating a bounding-box within each frame based on the attention saliency. The apparatus further includes means for temporally smoothing multiple bounding-boxes along the sequence of frames to obtain a smooth sequence of bounding-boxes. The apparatus also includes means for localizing an action location within each frame based on the smooth sequence of bounding-boxes.

In another aspect of the present disclosure, a non-transitory computer-readable medium with non-transitory program code recorded thereon is disclosed. The program code for generating bounding-boxes within frames of a sequence of frames is executed by a processor and includes program code to receive the sequence of frames. The bounding-boxes may be generated via a recurrent neural network (RNN) such as a long short-term memory (LSTM) network. The program code includes program code to generate an attention feature map for each frame of the sequence of frames. Each attention feature map indicates at least one potential moving object. The program code further includes program code to up-sample each attention feature map to determine an attention saliency for pixels in each frame. The program code still further includes program code to generate a bounding-box within each frame based on the attention saliency. The program code further includes program code to temporally smooth multiple bounding-boxes along the sequence of frames to obtain a smooth sequence of bounding-boxes. The program code also includes program code to localize an action location within each frame based on the smooth sequence of bounding-boxes.

Another aspect of the present disclosure is directed to an apparatus for generating bounding-boxes within frames of a sequence of frames. The bounding-boxes may be generated via a recurrent neural network (RNN) such as a long short-term memory (LSTM) network. The apparatus has a memory unit and one or more processors coupled to the memory unit. The processor(s) is configured to receive the sequence of frames. The processor(s) is also configured to generate an attention feature map for each frame of the sequence of frames. Each attention feature map indicates at least one potential moving object. The processor(s) is further configured to up-sample each attention feature map to determine an attention saliency for pixels in each frame. The processor(s) is still further configured to generate a bounding-box within each frame based on the attention saliency. The processor(s) is further configured to temporally smooth multiple bounding-boxes along the sequence of frames to obtain a smooth sequence of bounding-boxes. The processor(s) is also configured to localize an action location within each frame based on the smooth sequence of bounding-boxes.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a schematic diagram illustrating a recurrent neural network (RNN).

FIG. 5A is a diagram illustrating an image in a video frame for which a label is to be predicted in accordance with aspects of the present disclosure.

FIG. 5B is a diagram illustrating an exemplary architecture of an attention recurrent neural network for predicting an action in a video frame in accordance with aspects of the present disclosure.

FIG. 6 is a diagram illustrating an exemplary architecture for predicting action in a video frame in accordance with aspects of the present disclosure.

FIG. 7 illustrates an example of generating bounding-boxes according to an aspect of the present disclosure.

FIG. 8 illustrates a flow diagram for a method of generating bounding-boxes according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Motion information has traditionally been an important ingredient in automated video understanding, both for traditional video encodings using dense trajectories or more recent two-stream deep convolutional neural network architectures. Unlike convolutional neural networks intended for images, recurrent networks were originally proposed to elegantly model sequential data. A popular variant of recurrent networks is the long short-term memory (LSTM) architecture. The recurrent neural network model can handle vanishing gradients and is therefore better suited to model longer sequences. Consequently, recurrent neural networks may be a good fit for modelling the sequential temporal structure of videos to understand what is happening when and where in the audiovisual content.

As previously discussed, a conventional recurrent neural network architecture does not discriminate between the various spatial locations in a given video frame, thus treating all the locations equally. However, for understanding video, it is useful to consider that actions are performed by actors, and there are certain regions that are more interesting or pertinent than others. Some conventional approaches have proposed an attention RNN for action classification, which gives more importance to particular frame locations more relevant to actions of interest. This attention takes the form of a saliency map (e.g., a map of conspicuous regions), which instructs the recurrent neural network where to focus in a video frame.

The conventional attention recurrent neural network uses the recurrent neural network state at frame t to generate the attention for frame t+1, effectively predicting the location of the action in the next frame. However, the conventional attention RNN models rely on appearance only and ignore the temporal structure of sequential data, such as videos.

As previously discussed, conventional systems have proposed an attention RNN that predicts an attention saliency vector for the input that weighs different dimensions according to their importance. That is, the attention recurrent neural network predicts regions in the frame that are more relevant to the actions of interest.

Aspects of the present disclosure are directed to generating attention and localizing actions in a weakly-supervised manner using an attention recurrent neural network trained via action class labels for sequential data. Additionally, aspects of the present disclosure focus on the attention for actions predicted by an attention recurrent neural network rather than relying on action or object proposals. Thus, aspects of the present disclosure may not use frame-level detector training and action or object proposal classification.

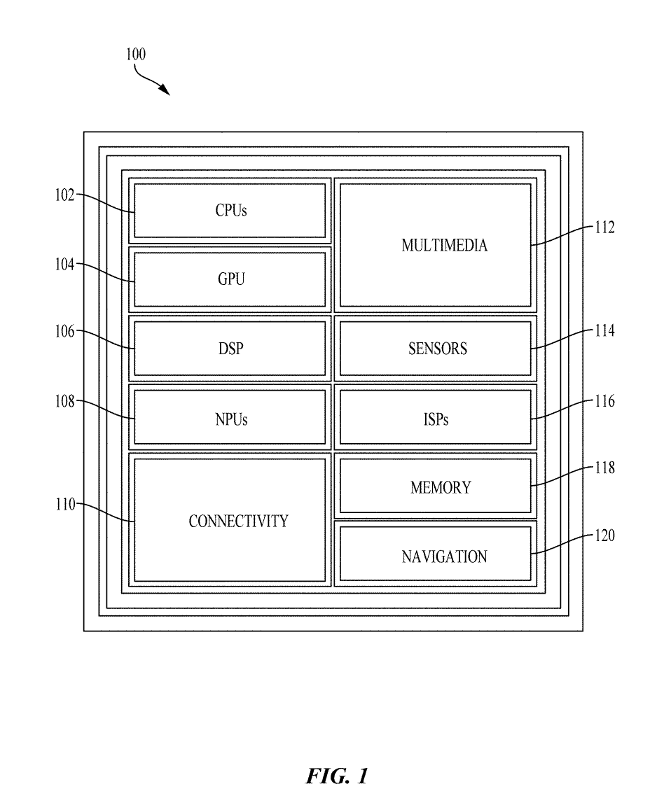

FIG. 1 illustrates an example implementation of the aforementioned action localization using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation 120, which may include a global positioning system.

The SOC may be based on an ARM instruction set. In an aspect of the present disclosure, the instructions loaded into the general-purpose processor 102 may comprise code for receiving a sequence of frames. The instructions loaded into the general-purpose processor 102 may also comprise code for generating an attention feature map for each frame of the sequence of frames. The instructions loaded into the general-purpose processor 102 may further comprise code for up-sampling each attention feature map to determine an attention saliency for pixels in each frame. The instructions loaded into the general-purpose processor 102 may still further comprise code for generating a bounding-box within each frame based on the attention saliency. Furthermore, the instructions loaded into the general-purpose processor 102 may also comprise code for generating a bounding-box within each frame based on the attention saliency. Additionally, the instructions loaded into the general-purpose processor 102 may further comprise code for temporally smoothing multiple bounding-boxes along the sequence of frames to obtain a smooth sequence of bounding-boxes. Finally, the instructions loaded into the general-purpose processor 102 may further comprise code for localizing an action location within each frame based on the smooth sequence of bounding-boxes.

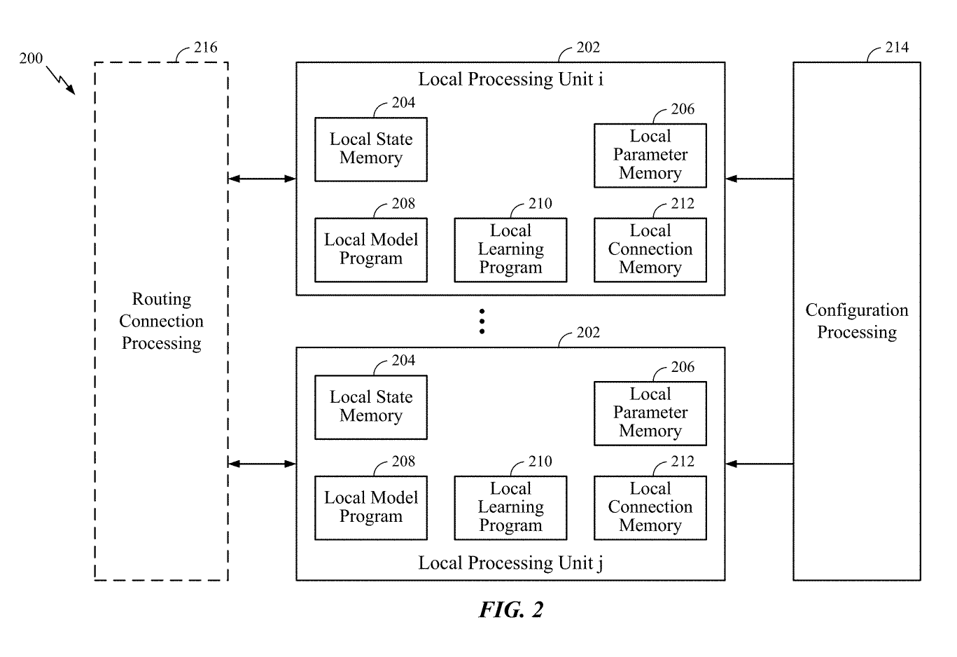

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

In one configuration, a processing model is configured for receiving the sequence of frames, generating a attention feature map for each frame of the sequence of frames; up-sampling each attention feature map to determine an attention saliency for pixels in each frame; generating a bounding-box within each frame of the sequence of frames based on the attention saliency; temporally smoothing multiple bounding-boxes along the sequence of frames to obtain a smooth sequence of bounding-boxes; and localizing an action location within each frame of the sequence of frames based on the smooth sequence of bounding-boxes. The model includes a generating means, up-sampling means, localizing means, and/or temporally smoothing means. In one configuration, the generating means, localizing means, and/or temporally smoothing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

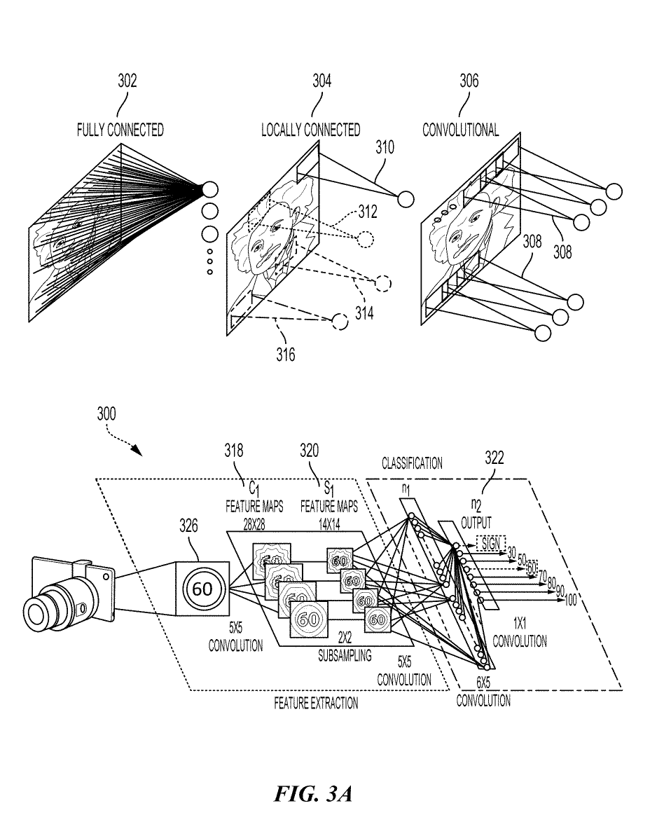

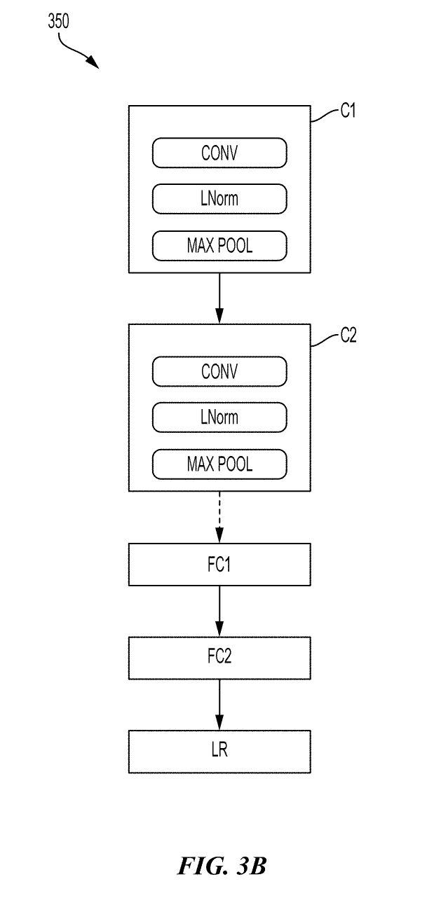

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

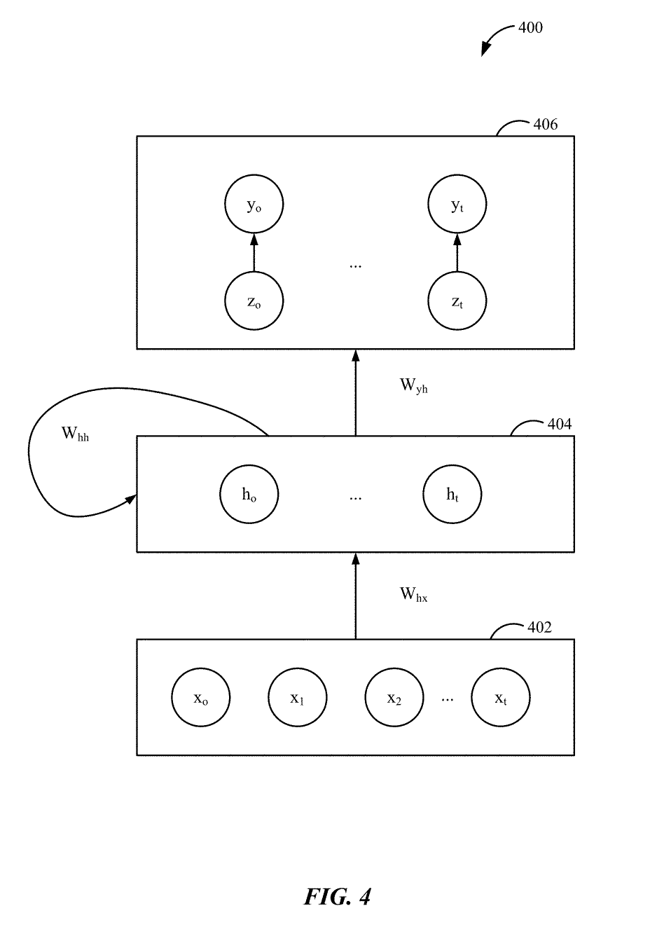

FIG. 4 is a schematic diagram illustrating a recurrent neural network (RNN) 400. The recurrent neural network 400 includes an input layer 402, a hidden layer 404 with recurrent connections, and an output layer 406. Given an input sequence X with multiple input vectors x_{T} (e.g., X={x₀, x₁, x₂ . . . x_{T}}), the recurrent neural network 400 will predict a classification label yₜ for each output vector z_{T} of an output sequence Z (e.g., Z={z₀ . . . z_{T}}). For FIG. 4, xₜε [symbol] ^{N}, yₜε [symbol] ^{C}, and zₜε [symbol] ^{C} As shown in FIG. 4, a hidden layer 404 with M units (e.g., hₒ . . . hₜ) is specified between the input layer 402 and the output layer 406. The M units of the hidden layer 404 store information on the previous values (\acute{t}<t) of the input sequence X. The M units may be computational nodes (e.g., neurons). In one configuration, the recurrent neural network 400 receives an input x_{T} and generates a classification label yₜ of the output z_{T} by iterating the equations:

sₜ=Wₕₓ_{^{x}}ₜ+Wₕₕhₜ₋₁+bₕ (1)

hₜ=ƒ(sₜ) (2)

oₜ=W_{yh}hₜ+b_{y} (3)

yₜ=g(oₜ) (4)

where Wₕₓ, Wₕₕ, and W_{yh} are the weight matrices, bₕ and b_{y} are the biases, sₜε [symbol] ^{M} and oₜε [symbol] ^{C} are inputs to the hidden layer 404 and the output layer 406, respectively, and ƒ and g are nonlinear functions. The function ƒ may comprise a rectifier linear unit (RELU) and, in some aspects, the function g may comprise a linear function or a softmax function. In addition, the hidden layer nodes are initialized to a fixed bias bi such that at t=0 hₒ=bi. In some aspects, bi may be set to zero (e.g., bi=0). The objective function, C(θ), for a recurrent neural network with a single training pair (x,y) is defined as C(θ)=Σₜ Lₜ (z, y(θ)), where θ represents the set of parameters (weights and biases) in the recurrent neural network. For regression problems, Lₜ=∥(zₜ−yₜ)²∥ and for multi-class classification problems, Lₜ=−Σⱼzₜⱼ log (yₜⱼ).

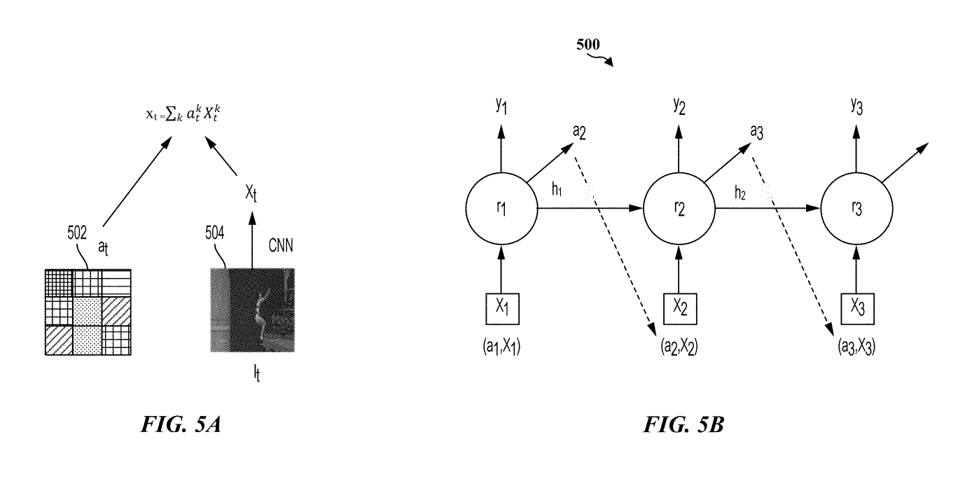

FIG. 5A is a diagram illustrating a frame (e.g., image) from a sequence of frames (e.g., a video) for which a classification label is to be predicted. Referring to FIG. 5A, the frame (Iₜ) 504 is provided as an input. An attention map (aₜ) 502 corresponding to the frame 504 may be predicted, for example by a multi-layer perceptron using the previous hidden state (hₜ₋₁) and the current feature map (Xₜ) as input. The attention map 502 may be combined with a feature map (Xₜ) generated from the frame 504. The feature map may be generated from an upper convolution layer of a convolutional neural network (e.g., FC2 in FIG. 3B) or via a recurrent neural network, for example. The feature map may be a two-dimensional (2D) or three-dimensional (3D) feature map, for appearance, optical flow, motion boundaries (e.g., gradient of optical flow), semantic segmentation at a feature level, and/or the like.

The attention map 502 provides a recurrent neural network, or a long short-term memory network, with the location of action in a frame 504. The action may be determined by using appearance motion information. As shown in FIG. 5A, an attention map aₜ and a feature map Xₜ may be combined by a weighted sum over all the spatial locations in the frame to compute a weighted feature map xₜ (e.g., xₜ=Σₖ aₜ^{k}Xₜ^{k}) as an input, where Xₜ^{k} indicates a feature vector (slice) in the feature map Xₜ at each location k, and aₜ^{k} is the weight in the attention map at its location.

FIG. 5B illustrates an example of an architecture 500 of an attention recurrent neural network for predicting an action in a frame. The exemplary architecture 500 may comprise a recurrent neural network, such as a long short-term memory (e.g., an attention long short-term memory (LSTM) network). The exemplary architecture 500 may include an input layer with input units (e.g., x₁, x₂, x₃, . . . ), a hidden layer having hidden units (e.g., r₁, r₂, r₃, . . . ) and an output layer with output units (e.g., y₁, y₂, y₃, . . . ) and attention maps (e.g., a1, a2, a3, . . . ). Each of the units may, for example, comprise artificial neurons or neural units. As shown in FIG. 5B, for a first frame, an attention map a₁ and a feature map X₁ are supplied and used to compute a first input x₁ to a first hidden layer r₁ of the attention recurrent neural network. In some aspects, the feature map of the first frame may comprise appearance (e.g., visual information form the content of the frame).

The first hidden unit r₁ predicts a first classification label y₁ and outputs a first hidden state h₁ that is used to generate a second attention map a₂ (e.g., subsequent attention map) for a second frame. The classification label may be referred to as a label, a class of interest, or an action label. Furthermore, the classification label indicates an action, an object, an event in the frame and/or the sequence of frames. The first hidden unit r₁ also outputs the first hidden state h₁ to a second hidden unit r₂. The hidden state at a time step is an internal representation of the neural network at that time step.

The second attention map a₂ and the feature map X₂ may be used to determine a second input x₂, which is input to the second hidden unit r₂ (that generates a second hidden state h₂). The hidden state of the second hidden unit r₂ is then used to predict a third attention map a₃ and a second classification label y₂ (e.g., the action) for the second frame.

The feature map X₃ and attention map a₃ may be used to determine input x₃, which is supplied to the third hidden unit r₃. The hidden state of the third hidden unit r₃ is used to predict the next attention map and an action label y₃ (e.g., the action of frame 3) for a third frame. This process may then be repeated for each subsequent frame at each succeeding time step.

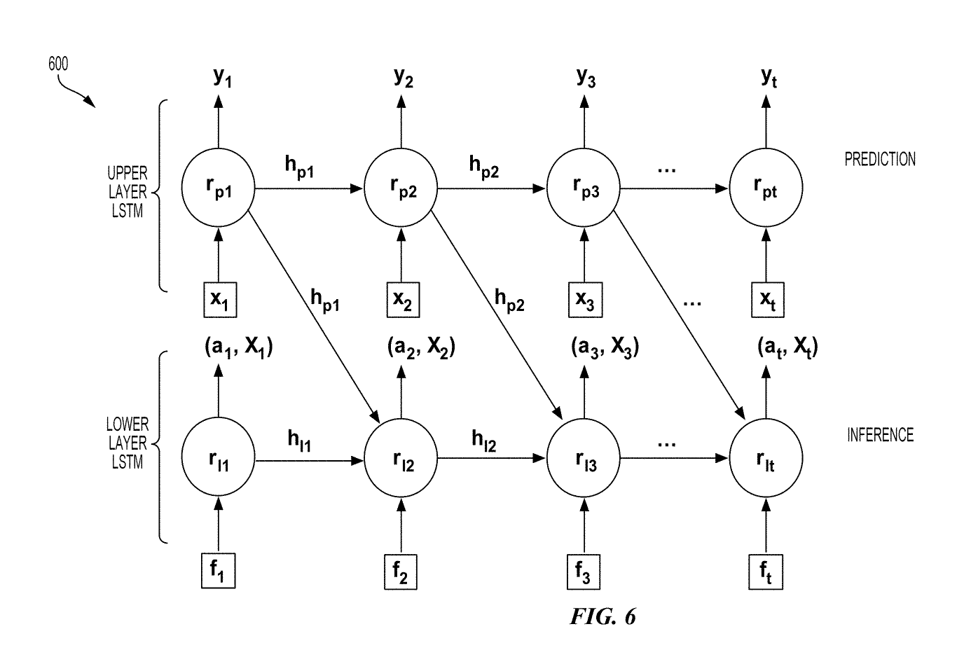

FIG. 6 is a diagram illustrating an exemplary architecture 600 for predicting action in a frame and/or a sequence of frames, in accordance with aspects of the present disclosure. The exemplary architecture 600 may be configured as a stratified network including upper layer recurrent neural networks and lower layer recurrent neural networks (e.g., two layers of recurrent neural networks). Although the exemplary architecture includes recurrent neural networks, this is exemplary, as other neural network architectures are also considered. For example, the upper layer may be a recurrent neural network and the lower layer may be an upper convolution layer of a convolutional neural network. For example, the upper layer or lower layer may comprise a recurrent neural network and the upper layer or lower layer may comprise multiple stacked recurrent neural network or long short-term memory layers.

The lower layer recurrent neural network uses the motion information fₜ and the hidden states from the previous frame to generate an attention saliency map for the current frame t. The motion information ƒₜ may be produced from optical flow, which may be estimated using the current frame and the next frame. The motion information ƒₜ may be produced via an upper convolution layer of a CNN. For example, the lower layer recurrent neural network unit rₗ₂ may use the hidden state of the previous hidden unit rₗ₁, the hidden state hₚ₁ of the upper layer recurrent neural network unit rₚ₁ along with motion information f₂ to generate the attention map a₂ for a second frame. As such, the lower layer recurrent neural network may provide the upper layer recurrent neural network with attention maps. The layer units may be artificial neurons or neural units.

The generated attention map aₜ for a current frame may be combined with a representation of the current frame of a sequence of frames (e.g., video stream). The frame representation may be a frame feature map Xₜ to create the input xₜ for the upper layer recurrent neural networks. In turn, the upper layer recurrent neural network may be configured to output a classification label yₜ for the current frame t. In addition, the upper layer recurrent neural network rₚₜ may output a hidden state hₜ of the upper layer recurrent neural network unit, which may be supplied to a subsequent hidden units r_{It} of the lower layer recurrent neural network and used to calculate or infer the attention map for the subsequent frame aₜ₊₁.

In operation, as shown in FIG. 6, for a first frame (time step t₁), an attention map a₁ may be predicted using a first lower hidden unit r_{I1}, which receives the motion information fₜ as input. The motion information may be produced from an optical flow, which may be computed using the first frame and the second frame. In one configuration, the optical flow is computed using two adjacent frames. The attention map a₁ is applied to the frame feature map X₁ to calculate an input x₁ comprising combined features. The combined features of the first input x₁ are output to the first upper hidden layer rₚ₁, which may predict a first classification label y₁. For example, the first classification label may label the frame as containing a diver, as shown in the frame 504 of FIG. 5A.

In addition, the first upper layer unit rₚ₁ outputs its hidden state hₚ₁ as an input to the subsequent lower hidden unit rₗ₂ at a next frame. In this example, the second lower hidden unit r_{I2} receives a lower unit hidden state h_{I1} from the first lower hidden unit r_{I1}. The hidden state of the first upper hidden unit rₚ₁ is also provided to the second upper hidden unit rₚ₂ of the upper layer LSTM. The hidden unit rₗ₂ also receives an motion input f₂ produced from optical flow. The optical flow input may be a field of vectors that predict how pixels at frame (e.g., frame t) will move to pixels at a next frame (e.g., frame t+1). For example, if the optical flow vector is a 2D vector expressed as 2,3 at x,y, the optical flow indicates that the pixels of frame t will move 2 pixels right and 3 pixels up in the subsequent frame t+1. That is, the optical flow tracks action in the pixels and considers motion to predict the most salient features within the video.

Using the optical flow and the hidden states (e.g., hₚ₁ and h_{I1}) from previous hidden units rₚ₁ and rₗ₁, a new attention map a₂ may be inferred via the hidden layer unit rₗ₂. The second attention map a₂ may be used with the frame appearance feature map of the second frame to calculate a second input x₂ to the second upper hidden unit rₚ₂. The second attention map a₂, which may include motion information (e.g., optical flow), may improve the identification of the regions of interest in the frame (e.g., actors) in comparison to previous frames. Thus, the second attention map may improve the label prediction.

The second upper hidden unit rₚ₂ may then predict a new hidden state hₚ₂ that infers a second classification label y₂. The hidden state of the second upper hidden unit rₚ₂ may be output to the third lower hidden unit r_{I3} and may be used along with the hidden state of the second lower hidden unit r_{I2} as well as the motion input (e.g., optical flow) f₃ to compute a third attention map a₃ for a third frame. The third attention map a₃ may be used along with the feature representation of the third frame (e.g., third frame appearance map X₃) to compute a third input x₃ for the third upper hidden unit rₚ₃, which in turn predicts a new hidden state that infers a classification label for the third frame. Thereafter, the process may be repeated.

Aspects of the present disclosure are not limited to the number of exemplary hidden units of a neural network shown in FIGS. 5B and 6. Of course, more or fewer hidden units of a neural network are also contemplated.

The attention map instructs a recurrent neural network of the location in a frame that an action takes place using appearance and motion information, such as optical flow. In some aspects, the optical flow may be described via a field of vectors that indicate how a pixel will move from one frame to the next. The optical flow tracks action in the video pixels and considers motion to predict salient features (e.g., important spatial locations) within the video.

For images and/or other types of inputs, vectorizing the input does not consider the spatial relationship (e.g., correlation) between the elements of the input, such as pixels. That is, the conventional attention recurrent neural network does not consider the spatial structure that characterizes the input vector xₜ.

Aspects of the present disclosure are directed to a neural network that replaces the inner products with convolutions to return two-dimensional output with spatial structure. The convolutional operation may preserve the spatial nature of an input, such as the spatial correlation of pixels in an image.

The frame may be a two-dimensional (2D) slice or three-dimensional (3D) slide of spatio-temporal data. Furthermore, the frame may be referred to as an image. The attention map provides the recurrent neural network with the location of action in a frame using appearance motion information, such as optical flow. In one configuration, the optical flow may be described by a field of vectors that indicate a predicted movement of a pixel from one frame to the next frame. That is, the optical flow tracks action in the pixels and considers the motion to predict the features with the greatest saliency within the sequence of frames.

Action Localization in Sequential Data with Attention Proposals from a Recurrent Neural Network

In conventional systems, such as conventional neural networks, a user may annotate (e.g., visually identify) the action in a video with a bounding-box. The annotation may be used to train a conventional neural network, or other classifiers, on the video samples. For example, a user may present a sequence of frames of a long jump and may annotate the portions of the frames that correlate to the long jump action. In this example, the conventional neural network uses the annotated action to learn the long jump action. Furthermore, based on the learning, the conventional neural network may identify a long jump action in a new frame sequences presented to the conventional neural network after the training is complete. The new frame sequence refers to a frame sequence that was not used (e.g., seen) during training.

In contrast to conventional systems, aspects of the present disclosure are directed to an attention recurrent neural network (RNN) that generates attention feature maps for each frame of a frame sequence. Each attention feature map of each frame indicates one or more potential actions, moving objects, and/or events. The potential actions, moving objects, and/or events may be referred to as an action proposal. In one configuration, the attention recurrent neural network is trained on action class labels provided for an input frame sequence. That is, the attention recurrent neural network is trained to classify frames based on an identified action. Furthermore, in one configuration, the bounding-boxes are generated from an attention map that captures the action. Although described generally with respect to recurrent neural networks, the present disclosure can employ a particular type of recurrent neural network, such as an long short-term memory (LSTM) network.

Aspects of the present disclosure are directed to generating attention in a weakly-supervised manner using an action class label for the sequential data (e.g., video). Additionally, aspects of the present disclosure are directed to drawing attention to actions predicted (e.g., potential actions) by an attention recurrent neural network rather than relying on object proposals (e.g., bounding-boxes annotated via user input). That is, aspects of the present disclosure localize action based on saliency determined from attention feature maps. Thus, in one configuration, the attention recurrent neural network is directed to identifying (e.g., localizing) an action location within each frame based on each bounding-box.

In one configuration, an attention recurrent neural network, such as a convolutional attention recurrent neural network, is trained with action class labels. The attention recurrent neural network may be trained with various labels describing one or more actions occurring in sequential data, such as a video. That is, the recurrent neural network may be trained using unannotated videos that may include one or more action class labels. The videos may be unannotated on a bounding-box level. That is, the videos may not include a user-supplied bounding-box. Training is performed with multiple video samples for each action class label. In addition, diversity of the action class labels may improve the training. The attention recurrent neural network may be provided with one or more action class labels associated with a long jump, such as “long jump,” “running,” “walking,” and/or “sports.” Another frame sequence may include a piano player and the action class labels may include, for example, “playing plano,” “music,” “instruments,” and/or “concerts.”

As another example, an image sensor on a car, such as a car dash camera, may be trained with various action class labels related to driving, such as “car,” “stop sign,” and/or “pedestrian.” As discussed above, the training may be performed with multiple video samples for each action class label. Furthermore, the recurrent neural network may obtain video in real-time. In this example, the user does not annotate the action in the captured video. Furthermore, it is desirable to interpret the action sequences of the captured frame sequences, such as the captured real-time video, to identify one or more potential actions, objects, and/or events in the frame sequence. Thus, it is desirable to provide action annotation, using a trained attention recurrent neural network, on frame sequences that have not been previously annotated with a bounding-box. For example, for a car, it may be desirable to provide action annotation when another car in proximity to the car with the image sensor switches lanes. The action annotation may alert the driver of action taking place in the car's surroundings.

Aspects of the present disclosure are not limited to training an attention recurrent neural network with only frame sequences of cars, long jump, and/or plano playing. The aforementioned training examples are merely examples and training on other actions is also contemplated.

Aspects of the present disclosure may provide the bounding-box location when the recurrent neural network is trained with an action class label. Additionally, or alternatively, the recurrent neural network may provide the bounding-box location if a lexicon of trained networks for various actions is available. In the car dash camera example, the action of a car switching lanes may be localized (e.g., identified) as long as the action class labels, such as a global action classifier, are available at run time.

The hidden state of the attention recurrent neural network is learned after training. Furthermore, after training, the attention recurrent neural network may receive new sequential data, such as a video. In this example, the new sequential data is different from the data used for training. In response to receiving the new sequential data, the attention recurrent neural network outputs a classification score for one or more actions, events, and/or object for each frame of the sequential data. Furthermore, the attention recurrent neural network also generates an attention feature map for each frame. The attention feature map is similar to the attention feature map aₜ discussed above. Each attention feature map may have an M×N dimension. In one configuration, the dimension of each attention feature map is 7×7.

After generating an attention feature map for each frame, the attention feature maps are up-sampled to generate attention saliency maps (W(x, y, t)). In one configuration, the attention saliency maps are projected back to the corresponding frames to provide a weight (W) at every pixel (x, y) in a frame (t). The attention saliency map of each frame may be sampled to determine action regions. The action regions are identified by pixels that have a weight that is greater than or equal to a threshold. Pixels with a weight that is greater than or equal to the threshold may be retained. Furthermore, the action region may be further identified by determining the retained pixels having a specific transition, such as a smooth transition, from one frame to a subsequent frame. A pixel, or group of pixels, may have a smooth transition when a potential action region overlaps in consecutive frames. For example, a potential action region in the first frame may overlap with a potential action region in the second frame. Thus, in this example, the potential action region is considered to have a smooth transition. A potential action region refers to a region in a frame that is expected (e.g., predicted) to have action.

In one configuration, to reduce or prevent the jitter of a bounding-box from one frame to a next frame (e.g., to have a smooth transition), temporal smoothing is applied on a sequence of bounding-boxes that span a set of frames from a sequence of frames. For example, to smooth the transition of bounding-boxes, weighted linear regression may be applied over the coordinates of bounding-boxes spanning a set of thirty frames from a sequence of frames. The weighted linear regression may smoothen the transition because the bounding-boxes are already capturing actions, events, and/or objects based on the attention maps from the attention recurrent neural network.

In one configuration, based on the sampling, each connected component is annotated with a bounding-box to identify a region in the frame that is more likely to contain a potential action, event, and/or object (e.g., action proposal). It should be noted that each frame may have one or more action regions. Furthermore, in one configuration, based on a bounding-box, the action is tracked through the sequential frames.

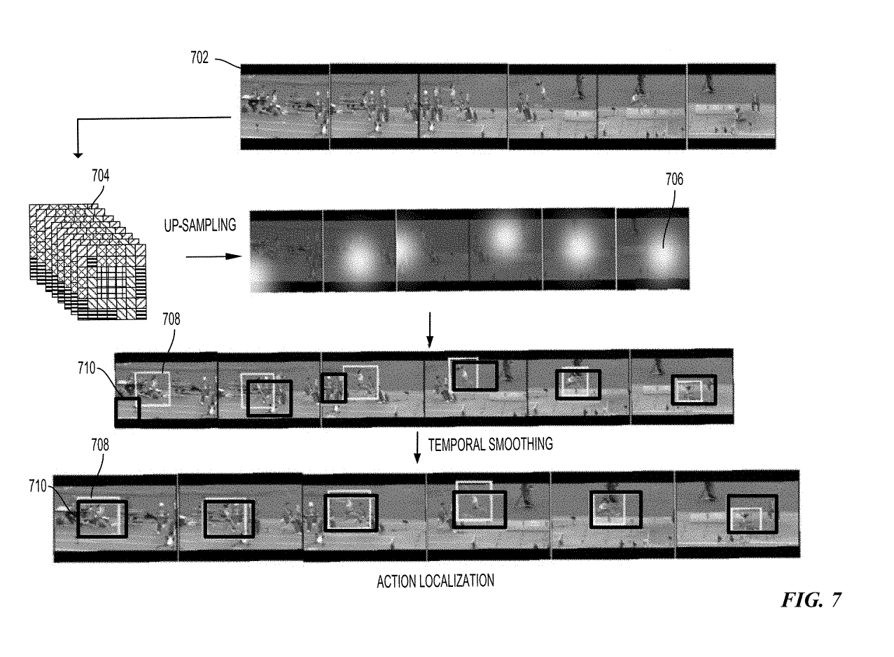

FIG. 7 illustrates an example of generating bounding-boxes according to an aspect of the present disclosure. As shown in FIG. 7, a trained attention recurrent neural network, such as a convolutional attention recurrent neural network, receives an input frame sequence 702. As shown in FIG. 7, the input frame sequence 702 is a sequence of frames of a long jump. In this example, the input frame sequence 702 has not been previously input to the trained attention recurrent neural network.

Based on the training, as each frame is received, the attention recurrent neural network outputs a classification score for a certain action and an attention feature map 704 for each frame. As shown in FIG. 7, multiple attention feature maps 704 are generated from a frame sequence. In one configuration, the attention recurrent neural network generates a classification score for an action class in each frame based on the training. As an example, the classification score may be 90% for long jump. Additionally, as shown in FIG. 7, each attention feature map 704 is up-sampled to the original image size. In most cases, a size of an attention map is small, such as seven pixels by seven pixels. Due to the small size, it may be difficult to sample or delineate an instance of action in a larger frame, such as 320×240. Therefore, to improve the localization of actions, the original frame size of the attention feature map is up-sampled. The up-sampled attention feature map is applied to the input frame sequence 702 to generate an attention saliency 706 over the input frame sequence 702. As previously discussed, the attention saliency may be represented as W(x, y, t). In FIG. 7, the attention saliency 706 highlights action regions of the input frame sequence 702.

Furthermore, after the attention saliency 706 is generated over the input frame sequence 702, the attention recurrent neural network may sample the pixels to determine the pixels with a weight that is greater than or equal to a threshold. The connected components of these sampled pixels are potential action regions and are enclosed by bounding-boxes. Furthermore, the attention recurrent neural network may identify regions that overlap in consecutive frames (e.g., regions with a smooth transition) by temporal smoothing over local sequence of bounding-boxes.

As shown in FIG. 7, after generating the attention saliency 706 for the sequence of frames, the action regions of the input frame sequence 702 are bounded by bounding-boxes 708 and 710. In the example of FIG. 7, a first bounding-box 708 shows the true locations of target actions. Furthermore, a second bounding-box 710 encloses the connected component from the attention saliency maps 706. Additionally, as shown in FIG. 7, after temporal smoothing is applied to the input frame sequence, the second bounding-boxes 710 have an improved alignment with the first bounding-boxes 708, thus resulting in improved action localization. Furthermore, the attention recurrent neural network may provide a confidence value for an action in the frame sequence. For example, based on the example of FIG. 7, the attention recurrent neural network may have a 90% confidence that the input frame sequence 702 is a long jump sequence and the bounding-boxes 708 710 annotate the long jumper that is performing the action (e.g., long jump).

According to an aspect of the present disclosure, the bounding-box may be used for data interpretation and/or data analysis. For example, the bounding-boxes may be used to track the action in frames. As another example, the bounding-boxes may be used to understand the temporal relationship of actors.

As previously discussed, in one example, a car with an image sensor (e.g., car dash camera) may capture a surrounding environment. In this example, the captured images may be displayed, in substantially real-time, to the driver via a display, such as a heads-up-display. Based on aspects of the present disclosure, for each received frame, a trained attention recurrent neural network may identify other cars (e.g., action objects) within the car's surroundings. Furthermore, the trained attention recurrent neural network may bound the action objects by a bounding-box to alert the driver of the presence of the action objects or to trigger automatic braking. As another example, when driving at night, the bounding-box may be used to alert the driver of an action object in the road (or to trigger automatic braking) to prevent an accident.

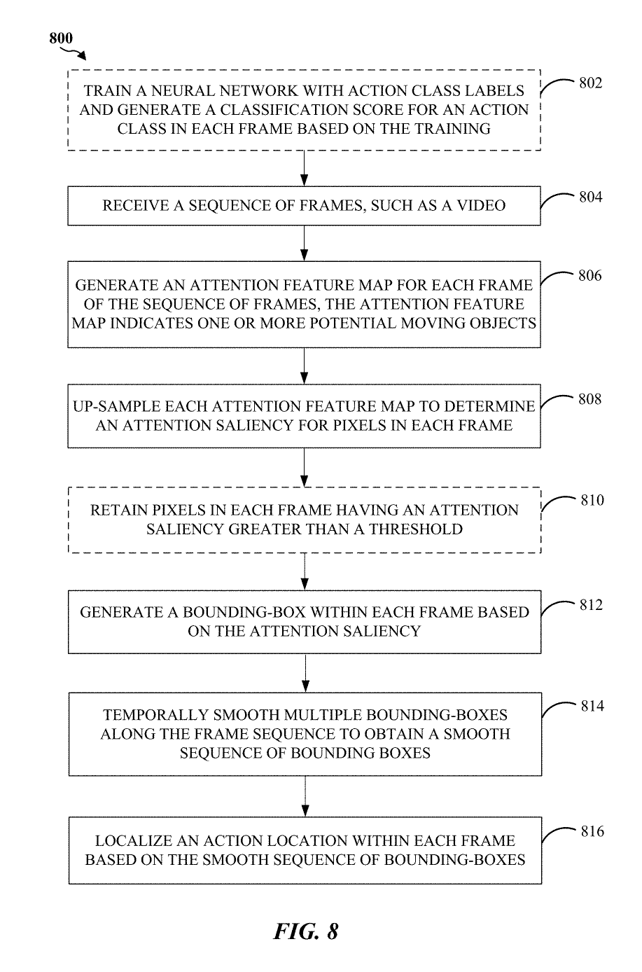

FIG. 8 illustrates a method 800 for generating bounding-boxes within frames of a sequence of frames, in accordance with aspects of the present disclosure. In some aspects, the bounding-boxes may be generated as the frames are received. Furthermore, in some aspects, the bounding-boxes may be generated via a neural network such as a recurrent neural network (RNN). In some aspects, the RNN may comprise an attention RNN or a long short-term memory (LSTM) network, for example. In block 802, method may optionally train the RNN (e.g., attention recurrent neural network) with action class labels and without the need of bounding-box level annotations. For example, the attention recurrent neural network may be provided with a frame sequence of a long jump. Training is performed with multiple video samples for each action class label. In addition, diversity of the action class labels may improve the training. The attention recurrent neural network may be provided with one or more action class labels associated with a long jump, such as “long jump,” “running,” “walking,” and/or “sports.”

In one configuration, in block 804, the method receives the sequence of frames, such as a video. The sequence of frames may be received in real-time via an image capturing device, such as a car dash camera, or the sequence of frames may be input from a pre-recorded video.

Furthermore, in block 806, the method generates an attention feature map for each frame of the sequence of frames. Each attention feature map indicates one or more potential moving objects. In some cases, the generating occurs in real-time. The attention map provides a recurrent neural network with the location of action in a frame. The action may be determined by using appearance motion information, such as optical flow. In some aspects, the optical flow may be described using a field of vectors that indicate how a pixel will move from one frame to the next. The optical flow tracks action in the pixels and considers motion to predict the most salient features within the video.

In one configuration, in block 808, the method up-samples each attention feature map to determine an attention saliency for pixels in each frame. In most cases, a size of an attention map is small, such as seven pixels by seven pixels. Due to the small size, it may be difficult to sample or delineate an instance of action in a larger frame, such as 320×240. Therefore, to improve the localization of actions, the original frame size of the attention feature map is up-sampled.

In one configuration, the attention saliency maps are projected back to the corresponding frames to provide a weight (W) at every pixel (x, y) in a frame (t). The attention saliency map of each frame may be sampled to determine action regions. The action regions are identified by pixels that have a weight that is greater than or equal to a threshold. In block 810, the method optionally retains pixels in each frame having an attention saliency that is greater than a threshold. That is, pixels with a weight that is greater than or equal to the threshold may be retained. Furthermore, the action region may be further identified by determining the retained pixels having a specific transition, such as a smooth transition, from one frame to a subsequent frame.

Furthermore, after up-sampling, in block 812, the method generates a bounding-box within each frame based on the determined attention saliency. Each bounding-box of a frame is specified to identify an action region within the frame. That is, the neural network (e.g., attention RNN) may retain pixels in each frame having an attention saliency greater than a threshold and draw each bounding-box based on each connected component of the retained pixels in each frame.

Additionally, in block 814, the method temporally smooths multiple bounding-boxes along the frame sequence to obtain a smooth sequence of bounding-boxes. The temporal smoothing may applied locally on the bounding-boxes spanning a specific number of consecutive frames within a time period. For example, the temporal smoothing may be applied to a span of thirty consecutive frames. Additionally, weighted linear regression may be applied over the coordinates of bounding-boxes spanning a set of thirty frames from a sequence of frames.

The above obtained sequences of bounding-boxes identify one or more areas of action, events, and/or objects within each frame. Action localization may refer to providing (e.g., identifying) the action locations by bounding-boxes and identifying the action class, such as long-jump. As previously discussed, the locations may be found after temporal smoothing and also after obtaining class labels with the attention recurrent neural network. The bounding-box may be provided when the recurrent neural network is trained with an action class label but not necessarily. Additionally, or alternatively, the method (e.g., via the RNN) may provide the bounding-box location if a lexicon of trained networks for various actions is available.

Finally, in block 816, the method localizes an action location within each frame based on the smooth sequence of bounding-boxes. Localization refers to providing the action locations by bounding-boxes and identifying the action class. The action class may be identified based on the training of the neural network (e.g., RNN). In one configuration, the attention recurrent neural network generates a classification score for an action class in each frame based on the training. In this configuration, each bounding-box corresponds to the action class. Furthermore, the action class and locations may be identified, and thereby localized, based on the temporally smoothened bounding-boxes.

In some aspects, the method 800 may be performed by the SOC 100 (FIG. 1) or the system 200 (FIG. 2). That is, each of the elements of the method 900 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of generating bounding-boxes within frames of a sequence of frames, comprising:
receiving the sequence of frames;
generating an attention feature map for each frame of the sequence of frames, each attention feature map indicating at least one potential moving object;
up-sampling each attention feature map to determine an attention saliency for pixels in each frame of the sequence of frames;
generating a bounding-box within each frame of the sequence of frames based on the attention saliency;
temporally smoothing a plurality of bounding-boxes along the sequence of frames to obtain a smooth sequence of bounding-boxes; and
localizing an action location within each frame of the sequence of frames based on the smooth sequence of bounding-boxes.

2. The method of claim 1, further comprising:
retaining pixels in each frame of the sequence of frames when the attention saliency is greater than a threshold; and
drawing each of the plurality of bounding-boxes based on each connected component of the retained pixels in the each frame of the sequence of frames.

3. The method of claim 1, further comprising:
generating the plurality of bounding-boxes with an attention recurrent neural network (RNN);
training the attention RNN with action class labels; and
generating a classification score for an action class in each frame of the sequence of frames based on the training, each of the plurality of bounding-boxes corresponding to the action class.

4. The method of claim 1, further comprising temporally smoothing for a number of frames of the sequence of frames within a time period.

5. The method of claim 1, in which the plurality of bounding-boxes are generated with an attention long short-term memory (LSTM) network.

6. An apparatus for generating bounding-boxes within frames of a sequence of frames, comprising:
a memory; and
at least one processor coupled to the memory, the at least one processor configured:
to receive the sequence of frames;
to generate an attention feature map for each frame of the sequence of frames, each attention feature map indicating at least one potential moving object;
to up-sample each attention feature map to determine an attention saliency for pixels in each frame of the sequence of frames;
to generate a bounding-box within each frame of the sequence of frames based on the attention saliency;
to temporally smooth a plurality of bounding-boxes along the sequence of frames to obtain a smooth sequence of bounding-boxes; and
to localize an action location within each frame of the sequence of frames based on the smooth sequence of bounding-boxes.

7. The apparatus of claim 6, in which the at least one processor is further configured:
to retain pixels in each frame of the sequence of frames when the attention saliency is greater than a threshold; and
to draw each of the plurality of bounding-boxes based on each connected component of the retained pixels in the each frame of the sequence of frames.

8. The apparatus of claim 6, in which the at least one processor is further configured:
to generate the plurality of bounding-boxes with an attention recurrent neural network (RNN);
to train the attention RNN with action class labels; and
to generate a classification score for an action class in each frame of the sequence of frames based on the training, each of the plurality of bounding-boxes corresponding to the action class.

9. The apparatus of claim 6, in which the at least one processor is further configured to temporally smooth for a number of frames of the sequence of frames within a time period.

10. The apparatus of claim 6, in which the at least one processor is further configured to generate the plurality of bounding-boxes with an attention long short-term memory (LSTM) network.

11. A non-transitory computer-readable medium having program code recorded thereon for generating bounding-boxes within frames of a sequence of frames, the program code comprising:
program code to receive the sequence of frames;
program code to generate an attention feature map for each frame of the sequence of frames, each attention feature map indicating at least one potential moving object;
program code to up-sample each attention feature map to determine an attention saliency for pixels in each frame of the sequence of frames;
program code to generate a bounding-box within each frame of the sequence of frames based on the attention saliency;
program code to temporally smooth a plurality of bounding-boxes along the sequence of frames to obtain a smooth sequence of bounding-boxes; and
program code to localize an action location within each frame of the sequence of frames based on the smooth sequence of bounding-boxes.

12. The non-transitory computer-readable medium of claim 11, in which the program code further comprises:
program code to retain pixels in each frame of the sequence of frames when the attention saliency is greater than a threshold; and
program code to draw each of the plurality of bounding-boxes based on each connected component of the retained pixels in the each frame of the sequence of frames.

13. The non-transitory computer-readable medium of claim 11, in which the program code further comprises:
program code to generate the plurality of bounding-boxes with an attention recurrent neural network (RNN)
program code to train the attention RNN with action class labels; and
program code to generate a classification score for an action class in each frame of the sequence of frames based on the training, each of the plurality of bounding-boxes corresponding to the action class.

14. The non-transitory computer-readable medium of claim 11, in which the program code further comprises program code to temporally smooth for a number of frames of the sequence of frames within a time period.

15. The non-transitory computer-readable medium of claim 11, in which the program code further comprises program code to generate the plurality of bounding-boxes with an attention long short-term memory (LSTM) network.

16. An apparatus for generating bounding-boxes within frames of a sequence of frames, comprising:
means for receiving the sequence of frames;
means for generating an attention feature map for each frame of the sequence of frames, each attention feature map indicating at least one potential moving object;
means for up-sampling each attention feature map to determine an attention saliency for pixels in each frame of the sequence of frames;
means for generating a bounding-box within each frame of the sequence of frames based on the attention saliency;
means for temporally smoothing a plurality of bounding-boxes along the sequence of frames to obtain a smooth sequence of bounding-boxes; and
means for localizing an action location within each frame of the sequence of frames based on the smooth sequence of bounding-boxes.

17. The apparatus of claim 16, further comprising:
means for retaining pixels in each frame of the sequence of frames when the attention saliency is greater than a threshold; and
means for drawing each of the plurality of bounding-boxes based on each connected component of the retained pixels in the each frame of the sequence of frames.

18. The apparatus of claim 16, further comprising:
means for generating the plurality of bounding-boxes with an attention recurrent neural network (RNN)
means for training the attention RNN with action class labels; and
means for generating a classification score for an action class in each frame of the sequence of frames based on the training, each of the plurality of bounding-boxes corresponding to the action class.

19. The apparatus of claim 16, further comprising means for temporally smoothing for a number of frames of the sequence of frames within a time period.

20. The apparatus of claim 16, further comprising means for generating the plurality of bounding-boxes with an attention long short-term memory (LSTM) network.
